(19) United States
(12) Patent Application Publication
(10) Pub. No.: US 2026/0065016 A1
(43) Pub. Date: Mar. 5, 2026

(54) ENHANCING COLLECTIVE INTELLIGENCE IN MULTI-AGENT SYSTEMS FOR ENTERPRISE SYNCHRONIZATION

(71) Applicant: International Business Machines Corporation, Armonk, NY (US)

(72) Inventors: Jeremy Ray Fox, Georgetown, TX (US); Martin G. Keen, Cary, NC (US); Fernando Luiz Koch, Palm Beach Gardens, FL (US); Jessica Nahulan, Markham (CA)

(73) Assignee: International Business Machines Corporation, Armonk, NY (US)

(21) Appl. No.: 18/823,073

(22) Filed: Sep. 3, 2024

(51) Int. Cl. G06N 3/044; G06N 3/006

(52) U.S. Cl. CPC G06N 3/044; G06N 3/006

(57) ABSTRACT

A digital assistant on a user interface, employing the trained human-emulative digital model is determined for a team to engender synchronization. The collective interactions between members of the team are analyzed. The customers associated with the first data center are identified. The share goal and interaction pattern based on the analyzed collective interactions are identified. The human-emulative digital model, using a deep learning algorithm, based on the at least one share goal and interaction pattern is trained.

### BACKGROUND

The present invention relates generally to harnessing collective intelligence of a project team. More particularly, the present invention relates to a method, system, and computer program designed for modeling, analyzing and enhancing both human interactions and human-digital human interactions, thereby ensuring the retention and sharing of knowledge and enabling organizations to increase or sustain high levels of synchronization, creativity, and productivity even as team compositions evolve.

In the digital era, organizations face significant challenges in capturing and understanding the complex dynamics of human interactions that are crucial for building and maintaining high-performance teams, fostering synchronized behavior, and unlocking organizational collective intelligence. The illustrative embodiments recognize that traditional collaboration tools and methods often fail to appreciate the nuanced, multi-faceted aspects of human communication and teamwork, resulting in a substantial risk of knowledge loss (i.e., tacit knowledge) when key team members depart. This tacit knowledge loss not only disrupts organizational continuity and impedes innovation but also reduces overall organizational efficiency as valuable insights, expertise, and contextual knowledge are lost. The illustrative embodiments recognize that the difficulty of preserving and transferring tacit knowledge, which is not easily documented, further exacerbates these challenges.

Additionally, the illustrative embodiments recognize that the departure of team members can initiate a cascade of additional problems within the organization. Decreased efficiency is an immediate consequence, as new members must invest significant time and effort to get up to speed, leading to project delays, missed deadlines, and reduced productivity. The absence of tacit knowledge can also cause innovation to stagnate, as the organization loses the unique insights and creative processes of those who have left. This stagnation may weaken the organization's competitive advantage, making it increasingly difficult to maintain its market position. Moreover, the departure of key individuals can lower morale among remaining team members, who may feel undervalued or concerned that their contributions will be overlooked. This can lead to disengagement, further attrition, and a negative impact on the organizational culture.

The illustrative embodiments recognize that the ripple effects may extend to compromised decision-making, where the absence of critical knowledge impairs the ability to make informed choices, leading to strategic misalignment. The illustrative embodiments recognize that replacing lost knowledge often incurs significant costs, whether through additional training, consulting, or hiring, putting a strain on resources. Furthermore, the loss of experienced team members can disrupt client relationships, as trust and satisfaction may decline without the continuity of service or expertise. This can lead to inconsistent quality in deliverables, damaging the organization's reputation. The illustrative embodiments recognize that ultimately, the combination of these factors can make it difficult for the organization to scale, hindering growth and adaptation to new opportunities.

Furthermore, the illustrative embodiments recognize that although integrating digital humans—virtual agents (e.g., agents) designed to imitate some human characteristics and interactions—may address some of above challenges, this integration introduces additional complexities and limitations. For instance, digital humans may struggle to fully capture and convey the subtleties of tacit knowledge and the intricate dynamics of real human interactions or human-digital human interactions. If not properly integrated, these digital humans might create gaps in understanding or fail to address the nuanced aspects of teamwork essential for organizational success.

Therefore, the illustrative embodiments recognize that it would be desirable to have methods, systems, and computer programs designed for advanced solutions that can accurately model, analyze, and enhance human interactions and human-digital human interactions ensuring that knowledge is retained and shared effectively, enabling organizations to maintain high levels of synchronization, creativity, and productivity even as team compositions change that would overcome the above disadvantages.

### SUMMARY

The illustrative embodiments provide for optimizing human interactions and human-digital human interactions in team-oriented environments, even the compositions of teams in the environment evolve. An embodiment includes analyzing collective interactions between members within the team. The embodiment includes identifying at least one share goal and interaction pattern based on the analyzed collective interactions. The embodiment includes training a human-emulative digital model, using a deep learning algorithm, based on at least one shared goal and interaction pattern. The embodiment includes identifying one or more customers associated with the first data center. The embodiment includes displaying a digital assistant on a user interface, the digital assistant employing the trained human-emulative digital model. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2A depicts a block diagram of a collaborative system for engendering synchronization within a team-orientated environment in accordance with an illustrative embodiment;

FIG. 2B depicts a block diagram of a collaborative system for engendering synchronization within a team-orientated environment in accordance with an illustrative embodiment;

FIG. 3 depicts a block diagram of a digital human emulation for engendering synchronization within a team-orientated environment in accordance with an illustrative embodiment;

FIG. 4 depicts a block diagram of a collective behavior analysis for engendering synchronization within a team-orientated environment in accordance with an illustrative embodiment;

FIG. 5 depicts a block diagram of a reinforcement learning adaptation for engendering synchronization within a team-orientated environment in accordance with an illustrative embodiment;

FIG. 6 depicts a block diagram of a user interface and personalization for engendering synchronization within a team-orientated environment in accordance with an illustrative embodiment.

### DETAILED DESCRIPTION

The present disclosure addresses the deficiencies recognized by the illustrative embodiments and described above by providing a process (as well as a system, method, machine-readable medium, etc.) for modeling, analyzing, and enhancing human interactions and human-digital human interactions, thereby ensuring that knowledge is retained and shared, and enabling organizations to maintain high levels of synchronization, creativity, and productivity even as team compositions change.

Providing improved functionality for modeling, analyzing, and enhancing human interactions and human-digital human interactions in a team-oriented environment matters for the following reasons. First, this improved functionality mitigates the risk of losing tacit knowledge, which is essential for ongoing success and innovation. Safeguarding this knowledge ensures that valuable insights and expertise are preserved. Second, this improved functionality enhances knowledge management and integration of digital tools can support more informed decision-making. Access to comprehensive and accurate information allows organizations to align strategies more effectively and avoid strategic misalignment. Third, the improved functionality reduces the costs associated with replacing lost knowledge by minimizing the need for extensive training, consulting, or hiring, thereby easing the strain on resources and improving the organization's financial health. Disclosed embodiments provide aforementioned advantages/benefits and technological improvements over the existing tools, techniques, and systems for modeling, simulating and optimizing human interactions and human-digital human interactions in a team-oriented environment.

An illustrative overview of an embodiment of the invention is as follows: optimizing for the modeling, analyzing, and enhancing human interactions and human-digital human interactions for engendering synchronization within a team, generally comprises four stages: 1) Collective Interactions, 2) Shared Goals and Interaction Patterns, 3) Human-emulative digital model Training, and 4) Digital Assistant and Digital Human Deployment.

### Collective Interactions

At the one stage, an embodiment of the invention, analysis of collective interactions between members within the team is conducted.

### Shared Goals and Interaction Patterns Stage

At another stage, identification of at least one share goal and interaction pattern based on the analyzed collective interactions is performed. In some embodiments, the second stage is integrated into the first stage, as one or a series of method steps.

### Human-Emulative Digital Model Training Stage

At the another stage, training a human-emulative digital model, using a deep learning algorithm, based on at least one share goal and interaction pattern is performed. In some embodiments, the third stage may be integrated into the first or second stages as one or a series of method steps.

### Digital Assistant and Digital Human Deployment Stage

At another stage, displaying a digital assistant on a user interface, based on the digital assistant employing the trained human-emulative digital model, is performed. In some embodiments, the fourth stage is integrated into the first, second, or third stages as one or a series of method steps.

Although the several stages described above were described in a specific order, it should be understood that other stages may be performed among the four stages or may be performed in an order other than that described, or stages may be adjusted so that they occur at slightly different times.

Aspects of the present disclosure can be implemented in a variety of technical use cases. The following use cases are merely exemplary and are not intended to limit the scope of the disclosure.

In a first use case, Wyatt is a marketing manager at a global consumer goods company and is tasked with leading a diverse team of marketing professionals spanning different regions and time zones. The team struggles with communication barriers, cultural differences, and a lack of shared understanding, leading to disjointed efforts, missed deadlines, inconsistent messaging, and a suboptimal customer experience. Wyatt employs the “SynchroMind” application, an embodiment of claim 1, to address these issues. The “SynchroMind” application begins by analyzing the team's collective interactions, including communication patterns, cultural differences, and collaboration issues. This analysis helps identify shared goals and recurring interaction patterns that are crucial for effective teamwork.

The application then trains a human-emulative digital model using deep learning algorithms, incorporating these insights to reflect the team's needs and dynamics accurately. These trained digital humans are integrated into a user interface as digital assistants, which are tailored to support real-time communication and cross-cultural empathy. By leveraging the digital humans' capabilities for synchronized behavior and shared understanding, the “SynchroMind” application facilitates improved alignment and knowledge sharing among team members, helping to streamline collaboration, ensure consistent messaging, and enhance overall campaign outcomes. This results in a more cohesive team, reduced missed deadlines, and an optimized customer experience. This approach addresses the complications simulating and optimizing human interactions and human-digital human interactions in a team-oriented environment.

In a second use case, Emma, a project manager at a healthcare research organization, is leading a team of data scientists working on a complex project that requires collaboration across multiple departments and stakeholders. However, the team is struggling with several challenges, including misaligned analyses, ineffective sharing of insights, and poor communication of project updates. These issues have led to delays and a lack of synergy among the team members. To address these challenges, Emma leverages the “SynchroMind” platform, which implements an embodiment of claim 1. The “SynchroMind” platform begins by analyzing the collective interactions within Emma's team. The “SynchroMind” platform examines the communication patterns, task coordination, and collaborative efforts among the team members, including both human and artificial agents.

Through this analysis, SynchroMind” platform identifies critical inefficiencies in the team's workflow and uncovers key shared goals that are not being effectively pursued. Based on these insights, “SynchroMind” platform uses a deep learning algorithm to train a human-emulative digital model. This human-emulative digital model is designed to reflect the decision-making processes and interaction patterns of the team members, taking into account the specific goals and challenges identified during the analysis. The trained human-emulative digital model is then integrated into a digital assistant, which is displayed on the team's user interface. This digital assistant becomes an interactive tool that guides the team members, helping them align their efforts with the project's shared goals, facilitating smoother communication, and optimizing the overall collaboration process. As a result of implementing the “SynchroMind” platform, Emma's team experiences a significant improvement in coordination and communication. The digital assistant aids in streamlining the project's workflow, ensuring that tasks are completed more efficiently and that critical insights are shared effectively across the team. By enabling synchronized cognitive collaboration, the “SynchroMind” platform helps Emma's team overcome the obstacles that previously hindered their progress, ultimately leading to the successful and timely completion of the research project.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

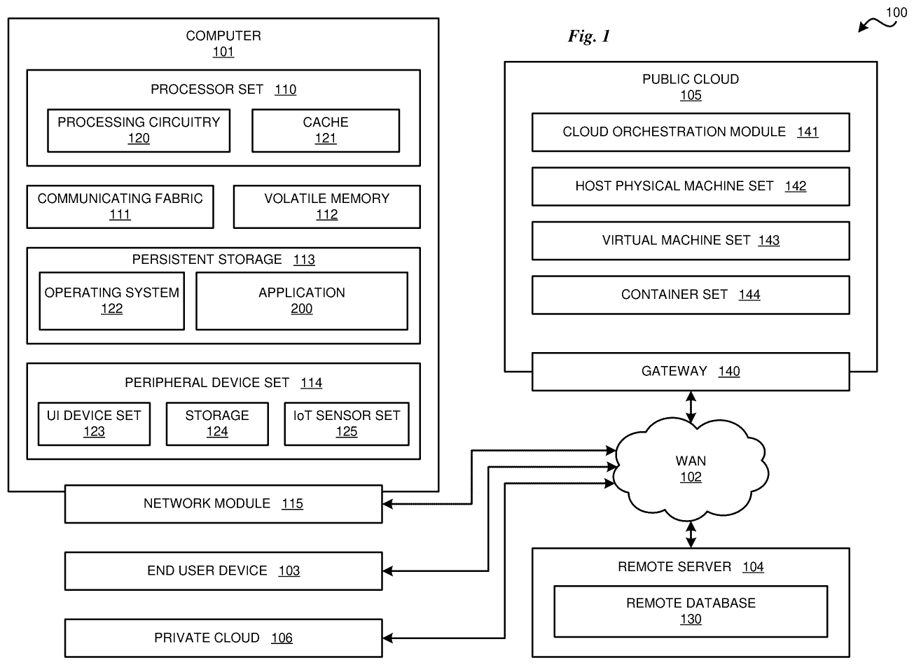

With reference to FIG. 1, this figure depicts a block diagram of a computing environment 100. Computing environment 100 contains an example of an environment for the execution of at least some computer code involved in performing the inventive methods, such as an example application 200 for engendering synchronization across project teams and organizations. The following are definitions for terms used throughout the disclosure. “project team” is a term used in the present disclosure to describe a group of humans and/or artificial agents (such as AI systems or software bots) working together on a specific project or collective action or endeavor; a “project team” may include human members with various roles, expertise, and responsibilities, as well as artificial agents that interact with the humans to assist in tasks, decision-making, and overall project execution; the term “project team” may be used interchangeably with the term “team”; “member” is a term used in the present disclosure to describe an individual or entity that is part of the project team; “members” may include both human members, who are natural persons contributing their skills and expertise, and human-emulative digital models and agents, which are artificial entities such as artificial intelligence (AI) systems or software bots; a “member” may play a role in the project team's collective efforts, interacting with other members and/or participating in the overall project activities; “synchronization” is a term used in the present disclosure to describe process of aligning and coordinating the actions, goals, and interactions of the members within a project team (including both humans and agents); “collective interaction” or “collective interactions” is a term used in the present disclosure to describe combined and/or interrelated actions, communications, and behaviors that occur between multiple members of a project team, which can include both humans and agents; the term “collective interaction” may be used interchangeably with term “collective behavior”; “human” is a term used in the present disclosure to describe a member of the project team, organization, group, or company, who is a natural or real person, as opposed to an artificial agent or machine; the term “human” may be used interchangeably with terms “human user” or “user”; “agent” is a term used in the present disclose to describe an artificial entity within the project team, such as an artificial intelligence (AI) system, chatbot, software bot, or autonomous machine, that interacts with human team members; an “agent” may capable of performing tasks, making decisions, and engaging in communication based on the agent's programming or learned behaviors; unlike “humans,” “agents” are designed to operate according to algorithms, rules, or machine learning models, contributing to the project through automated or semi-automated actions and interactions, without the sophisticated emulation of human behavior or appearance that characterizes a human-cumulative digital model; the term “agent” may be used interchangeably with terms “agent user,” or “digital human,” or “artificial agent”; the term “human-emulative digital model” is used in the present disclosure to describe a digital construct designed to mimic human behavior, interactions, and decision-making processes; unlike a “agent,” a “human-emulative digital model” is equipped with sophisticated algorithms or machine learning models that enable the human-emulative digital model to engage in realistic and human-like interactions, replicating not only the human actions but also the nuances of human communication and social behavior, contributing to a project through automated or semi-automated actions and interactions; “digital assistant” is a term used in the present disclosure to describe a virtual tool, software entity, agent, or human-emulative digital model that presents to or interacts with users or members through a user interface (UI) or graphical user interface (GUI); a “digital assistant” may be designed to support and facilitate tasks, decision-making, and communication based on a trained human-emulative digital model; a “digital assistant” may be personalized to meet the specific needs and preferences of individual team members, helping them achieve their goals and enhance their productivity within the project team; for instance, a “digital assistant” might use audio to communicate with a team member if it has determined that this individual team member learns best through auditory instructions; alternatively, or additionally, the assistant may opt for visual communication (or a mix of auditory, visual, and or/kinesthetic communication), such as images or PowerPoint slides, if that method is more effective for the team member; a “digital assistant” may leverages insights from the analysis of collective interactions and goals to provide relevant assistance and guidance; “shared goal” is a term used in the present disclosure describe a specific objective or desired outcome identified for the project team, including both human members and agents; a “shared goal” may be determined based on the “collective interactions” within the project team and represent the targets or milestones that guide the project team's efforts; “interaction pattern” is a term used in the present disclosure to describe a recurring and/or identifiable way in which members of the project team, including both humans and agents, engage with each other; a “interaction pattern” may include the typical sequences of actions, communications, and responses that occur during their interactions; an “interaction pattern” may be used or analyzed to reveal how team members collaborate, how tasks are coordinated, and how information is exchanged, providing insights into the dynamics and efficiency of the team's collective behavior; a “interaction pattern” within a project team may be observed in various ways: for example, in communication sequences, team members may follow an interaction pattern where the team members send weekly email updates detailing progress, which are then reviewed and responded to by other team members; another example, in decision-making processes, an “interaction pattern” may involve drafting a proposal, gathering feedback through iterative discussions, and finalizing decisions through a structured voting process; “collaborative system” is a term used in the present disclosure to describe an integrated environment where multiple team members (e.g., participants), including humans and agents (such as AI systems or digital humans), work together to achieve shared goals; a “collaborative system” may facilitate communication, coordination, and interaction among its members, leveraging technology to enhance collaboration, streamline workflows, and optimize overall performance; additionally, a “collaborative system” may use technology integration to enhance communication and cooperation among the collaborative system's team members; this “collaborative system” may leverage various technological platforms—such as project management software, shared drives, and communication tools—to facilitate seamless interactions and information exchange; technological platforms employed by “collaborative system” may enable the collaborative system to support real-time collaboration through tools like instant messaging, email, and video conferencing, while also managing and analyzing data using machine learning algorithms and social network analysis techniques; the term “collaborative system” may be used interchangeably with the term “collaborative network”; “feature” is a term used in this disclosure to describe a specific attribute or element extracted from the raw dataset, which may be helpful for analyzing or modeling human, human-human, and/or human-agent (e.g., human-digital human) interactions; “features” may be distinct aspects of the data providing insights into project team and member behaviors and patterns; for example, “features” may include speech patterns, such as tone and pitch, facial expressions that reveal human emotions, and gestures that indicate intent; these “features” may be useful for training human-emulative digital models; the term “features” may be used interchangeably with term “relevant feature”; “deep learning techniques and algorithms” is a term used in the present disclosure to describes methods in machine learning that use complex neural network architectures to analyze and model data, enabling emulated human-like behavior and generating natural language responses; “deep learning techniques and algorithms” may includes: recurrent neural networks (RNNs), which process sequential data by incorporating feedback loops, long short-term memory (LSTM) networks, which manage long-term dependencies in sequences using specialized gates; transformers, which utilize self-attention mechanisms for efficient sequence processing and natural language tasks, generative adversarial networks (GANs), which involve a generator and a discriminator network competing to create realistic data samples; the term “deep learning techniques and algorithms” may be used interchangeably terms “deep learning algorithm” or “deep learning algorithms”; “natural language processing (NLP)” is a term used in the present disclosure to describe a branch of artificial intelligence focusing on permitting computers to understand, interpret, and generate human language; “natural language processing (NLP)” may involves various tasks such as text analysis to extract information, speech recognition to convert spoken language into text, and language generation to produce coherent responses; “natural language processing (NLP)” may use techniques such as named entity recognition for identifying key entities in text, sentiment analysis for assessing emotional tone, and intent classification for understanding user intentions;

In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

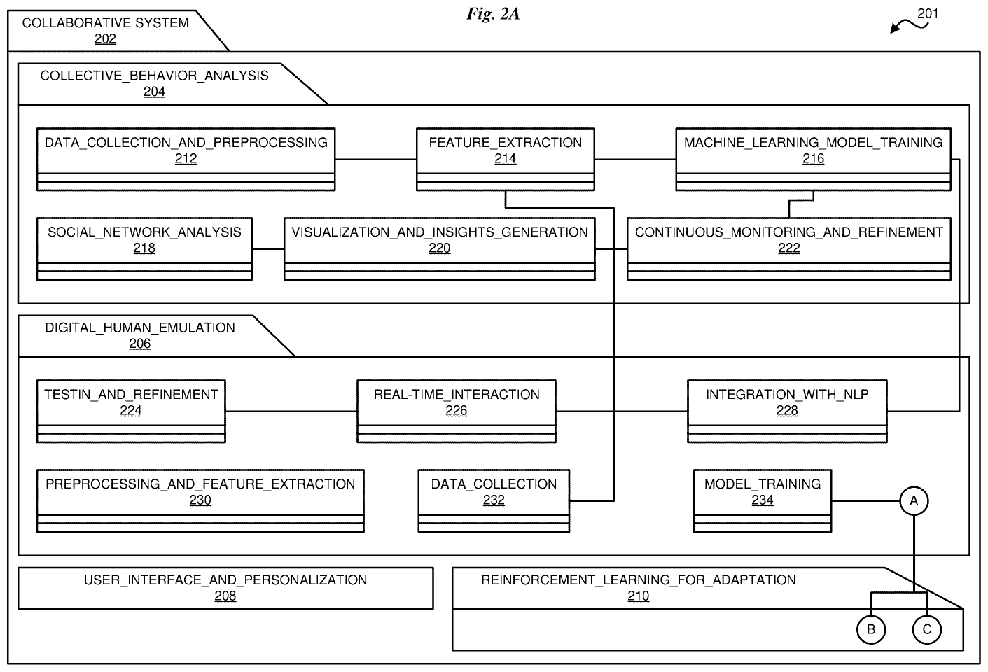

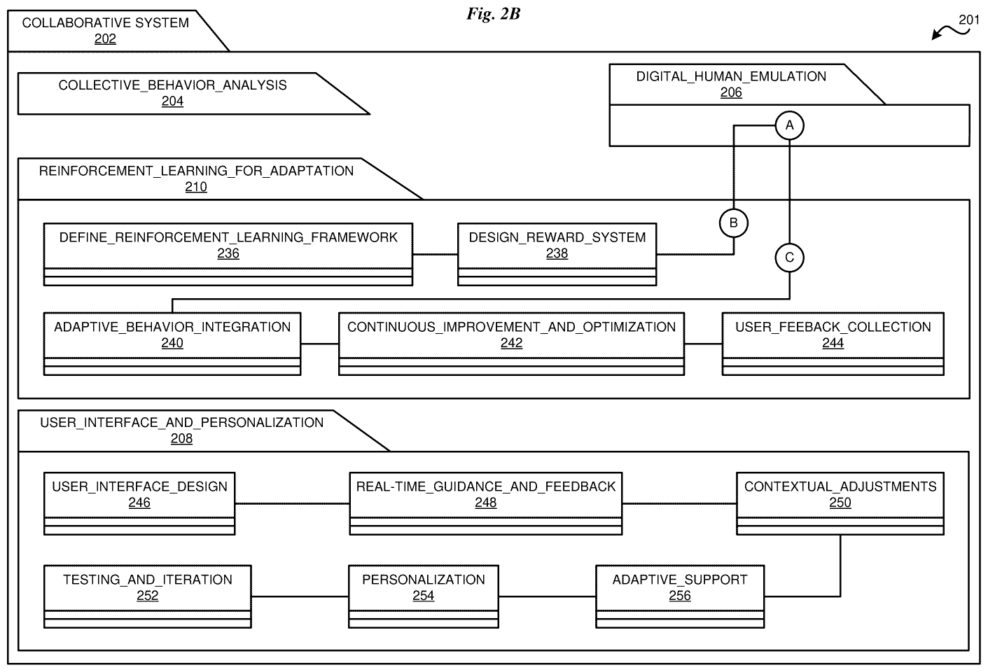

With reference to FIGS. 2A & 2B, these figures depict block diagram 201 for a collaborative system in accordance with an illustrative embodiment. In the illustrated embodiment, block diagram 201 includes collaborative system component 202 consisting of one or more of the four sub-component: collective behavior analysis sub-component 204, digital human emulation sub-component 206, reinforcement learning for adaption sub-component 210, and user interface and personalization sub-component 208. These sub-components may interrelate, communicate (e.g., Representational state transfer (RESTful) Application Program Interfaces (APIs) for communication between the digital human emulation component and other system modules, Open Authorization (OAuth) for secure user authentication, JavaScript Object Notation (JSON) or Extensible Markup Language (XML) for data exchange, or WebSocket for real-time interaction), and interact in a workflow to enable the functionality of collaborative system component 202, as further detailed below.

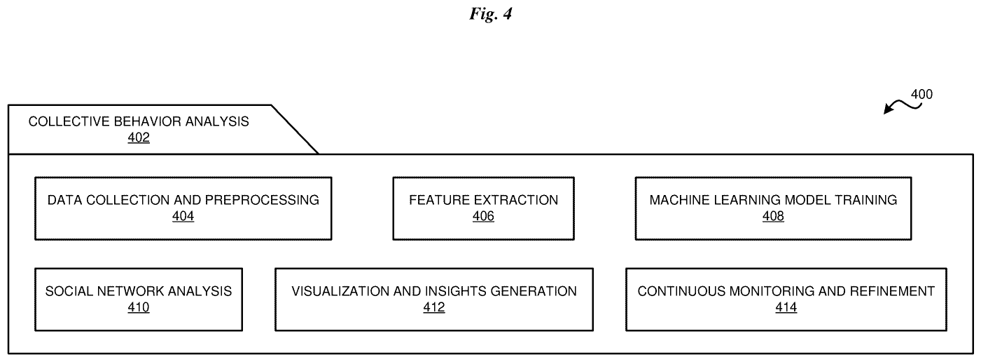

Referring to FIG. 2A, collective behavior analysis sub-component 204 examines collective behaviors (e.g., collective interaction) within a collaborative system (e.g., a share drive, or project management software) by leveraging machine learning algorithms and social network analysis techniques. Collective behavior analysis sub-component 204 aims to identify shared goals, interaction patterns, and optimal information flow within the collaborative system. Collective behavior analysis sub-component 204 may include one or more of the following modules: data collection and preprocessing module 212, feature extraction module 214, machine learning model training module 216, social network analysis 218, visualization and insights generation 220, and continuous monitoring and refinement 222. Detailed implementation of these modules is provided in FIG. 4 below.

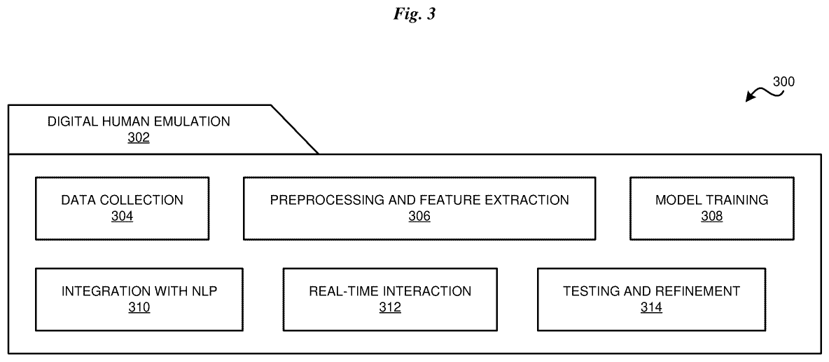

Referring to FIG. 2A, digital human emulation sub-component 206 focuses on mimicking, emulating or replicating human characteristics, behaviors, and interactions in the digital assistants (e.g., digital humans) employing trained human-emulative digital models within a collaborative system (e.g., a share drive, or project management software). These human-emulative digital models are integrated into collaborative systems (e.g., shared drives or project management software), enabling realistic and effective communication between agents and humans. Digital human emulation sub-component 206 may include one or more of the following modules: data collection module 232, preprocessing and feature extraction module 230, model training module 234, integration with NLP (natural language processing) module 228, real-time interaction module 226, and testing and refinement module 224. Detailed implementation of these modules is provided in FIG. 3 below.

Referring again to FIG. 2A, user interface and personalization sub-component 208 and the reinforcement learning for adaptation sub-component 210 are depicted in unexpanded forms, without modules, to emphasize their interrelation with the digital human emulation sub-component 206 and the collective behavior analysis sub-component 204. In FIG. 2B, user interface and personalization sub-component 208 and the reinforcement learning for adaptation sub-component 210 are shown in expanded forms, including their respective modules, while digital human emulation sub-component 206 and the collective behavior analysis sub-component 204 are shown in unexpanded forms. It should be noted that the sub-components in FIGS. 2A and 2B are identical.

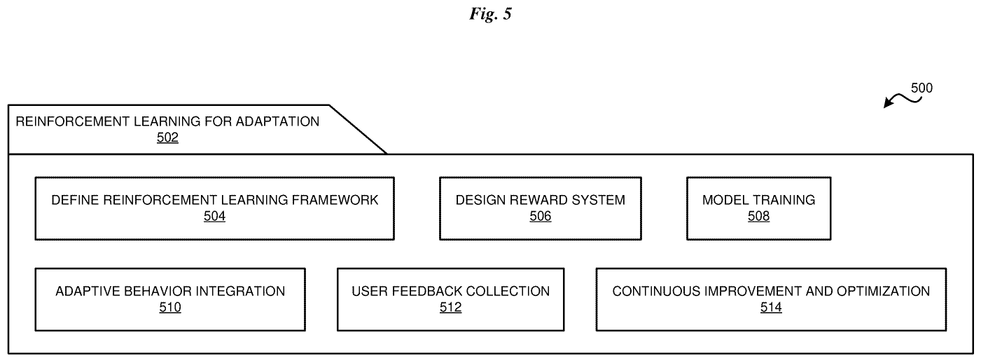

Referring to FIG. 2B, reinforcement learning for adaptation sub-component 210 employs reinforcement learning algorithms to adapt or adjust the behaviors of the digital assistants (e.g., digital humans) employing trained human-emulative digital models, based on human or user feedback. Reinforcement learning for adaptation sub-component 210 permits the digital assistants (e.g., digital humans) employing human-emulative digital models to continuously improve their performance and synchronization within the collaborative system (e.g., a share drive, or project management software). Reinforcement learning for adaptation sub-component 210 may include one or more of the following modules: define reinforcement learning framework module 236, design reward system module 238, adaptive behavior integration 240, user feedback collection 244, and continuous monitoring and optimization 242. Detailed implementation of these modules is provided in FIG. 5 below.

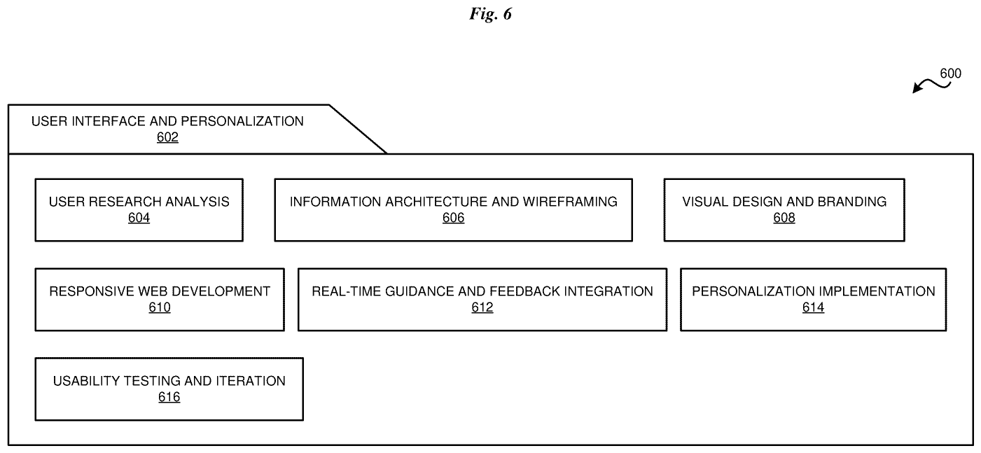

Referring to FIG. 2B, user interface and personalization sub-component 208 delivers a digital assistant-based interface (e.g., user interface (UI) device set 123) personalized or tailored to the human users of the collaborative system (e.g., a share drive, or project management software). User interface and personalization sub-component 208 provides real-time guidance and feedback from employed human-emulative digital models, offering personalized recommendations and contextual adjustments to enhance the experience for human users. User interface and personalization sub-component 208 includes one or more of the following modules: user interface design module 246 (e.g., user research analysis module 604, information architecture and wireframing module 606, and visual design and branding module 608), real time guidance and feedback 248 (e.g., real-time guidance and feedback integration module 612), personalization module 254 (e.g., personalization module 254), contextual adjustments module 250 (e.g., responsive web development module 610), adaptive support module 256 (e.g., responsive web development module 610), and testing and iteration module 252 (e.g., usability testing and iteration module 616). Detailed implementation of these modules is provided in FIG. 6 below.

With reference to FIG. 3, this figure depicts a block diagram 300 of a digital human emulation component 302 in accordance with an illustrative embodiment. It should be noted that digital human emulation component 302 is an instance of digital human emulation sub-component 206 mentioned earlier. In the illustrated embodiment, digital human emulation component 302 includes one or more of following modules: data collection module 304 (e.g., data collection module 232), preprocessing and feature extraction module 306 (e.g., preprocessing and feature extraction module 230), model training module 308 (e.g., module training module 234), integration with NLP (natural language processing) module 310 (e.g., integration with NLP module 226), real-time interaction module 312 (e.g., real time interaction module 226), and testing and refinement module 314 (e.g., testing and refinement module 224). These modules may interrelate, communicate (e.g., Representational state transfer (RESTful) Application Program Interfaces (APIs) for communication between the digital human emulation component and other system modules, Open Authorization (OAuth) for secure user authentication, JavaScript Object Notation (JSON) or Extensible Markup Language (XML) for data exchange, or WebSocket for real-time interaction), and interact in a workflow to enable the functionality of digital human emulation component 302, as further detailed below.

Data collection module 304 gathers or collects a diverse and rich dataset (e.g., data) of human interactions, conversations, and behaviors for training human-emulative digital models. This dataset may include a wide range of scenarios and cultural contexts. Then, data collection module 304 outputs raw data or dataset (e.g., data), including audio recordings, emails, textual data, facial expressions, and gestures, to the preprocessing and feature extraction module 306, where the raw data or dataset (e.g., data) is cleaned and refined for further use.

Preprocessing and feature extraction module 306 cleans and preprocesses the collected dataset (received as input from data collection module 304) by removing noise and irrelevant information or data. Additionally, preprocessing and feature extraction module 306 extracts from the collected dataset, relevant features (e.g., specific attributes or elements extracted from the data that is relevant for analyzing or modeling human interactions), such as speech patterns, facial expressions, and gestures. In short, preprocessing and feature extraction module 306 extracts relevant features that are helpful inputs for model training module 308.

Model training module 308 employs deep learning techniques and algorithms, such as recurrent neural networks (RNNs) or transformers (e.g., Recurrent Neural Networks (RNNs), Long Short-Term Memory (LSTM), Transformers, Generative Adversarial Networks (GANs)), to train human-emulative digital models that emulate human-like behavior and generate natural language responses. These human-emulative digital models are trained using the preprocessed dataset from preprocessing and feature extraction module 306, with adjustments made to the model architecture and hyperparameters of human-emulative digital models to achieve optimal or appropriate results. Furthermore, the trained human-emulative digital models are then integrated with natural language processing algorithms through integration with NLP module 310, enabling the human-emulative digital models to understand and produce human-like language.

Integration with NLP module 310 incorporates the human-emulative digital models from model training module 308 to enable human-emulative digital models to understand and generate human-like responses. This integration of the trained human-emulative digital models with NLP may involve techniques and algorithms, such as named entity recognition, sentiment analysis, and intent classification. Additionally, this integration with NLP module 310 may utilize tools and frameworks including TensorFlow, PyTorch, Keras, OpenAI GPT (Generative Pre-trained Transformer), Google Cloud Natural Language Processing API (Application Program Interface), and Microsoft Azure Cognitive Services, as known to those skilled in the art.

Real-time interaction module 312 facilitates voice-based communication through speech recognition and synthesis, integrates facial recognition for visual interactions, and incorporates gesture recognition for non-verbal communication. Real-time interaction module 312 may integrate or work in conjunction with other modules to enhance cooperation and communication. For example, real-time interaction module 312 relies on data collection module 304 for raw data or dataset, such as audio recordings, facial expressions, and gesture data, for collecting live collective interactions between team members. Additionally, preprocessing and feature extraction module 306 processes and refines these datasets or data by extracting relevant features (e.g., specific attributes or elements extracted from the data that is relevant for analyzing or modeling human interactions) like speech patterns and gestures, providing these relevant features to real-time interaction module 312 to support accurate interpretation and response.

Still referring to FIG. 3, testing and refinement module 314 conducts comprehensive testing of digital human emulation component 302 to validate the effectiveness of digital human emulation component 302 in simulating human-like behavior and interactions in human-emulative digital models. Additionally, testing and refinement module 314 may involve gathering feedback from human uses and iterating on human-emulative digital models and algorithms to enhance the performance and realism of the human-emulative digital models.

With reference to FIG. 4, this figure depicts block diagram 400 of a collective behavior analysis component 402 in accordance with an illustrative embodiment. It should be noted that a collective behavior analysis component 402 is an instance of collective behavior analysis sub-component 204 mentioned earlier. In the illustrated embodiment, collective behavior analysis component 402 includes one or more of the following modules: data collection module 404 (e.g., data collection and preprocessing module 212), feature extraction module 406 (e.g., feature extraction module 214), machine learning model training module 408 (e.g., machine learning model training module 216), social network analysis 410 (e.g., social network analysis 218), visualization and insights generation 412 (e.g., visualization and insights generation 220), and continuous monitoring and refinement 414 (e.g., continuous monitoring and refinement 222). These modules may interrelate, communicate (e.g., Representational state transfer (RESTful) Application Program Interfaces (APIs) for communication between the digital human emulation component and other system modules, Open Authorization (OAuth) for secure user authentication, JavaScript Object Notation (JSON) or Extensible Markup Language (XML) for data exchange, or WebSocket for real-time interaction), and interact in a workflow to enable the functionality of collective behavior analysis component 402, as further detailed below.

Data collection and preprocessing module 404 gathers relevant data from the collaborative system (e.g., a share drive, or project management software), including team member interactions, communication logs, and task assignments. Data collection and preprocessing module 404 then cleans and preprocesses the data by removing noise and irrelevant information or data. The resulting clean/preprocessed data (outputted by data collection and preprocessing module 404) is then made available for use as input by other modules.

Feature extraction module 406 identifiers and extracts features (e.g., specific attributes or elements extracted from the data that is relevant for analyzing or modeling human interactions) from the collected data from data collection and preprocessing module 404 to identify and capture patterns of behavior and interaction (e.g., collective interaction or interaction patterns) within the collaborative system (e.g., a share drive, or project management software). The extracted features, which may include user activity levels, communication frequency, topic clustering, and sentiment analysis, are then used as input for other modules (e.g., machine learning model training module 408).

Machine learning model training module 408 utilizes machine learning algorithms, including clustering algorithms (e.g., k-means), classification algorithms (e.g., decision trees, random forests, support vector machines), and natural language processing algorithms (e.g., sentiment analysis, topic modeling), along with other techniques known to those skilled in the art, to analyze the collected data (from feature extraction module 406 for example) and identify shared goals, interaction patterns, and information flow (i.e., insights) within the collaborative system. The insights generated are then used as input for other modules.

Social Network Analysis module 410 applies techniques such as network visualization and centrality analysis to understand the structure and dynamics of the collaborative system (e.g., a share drive, or project management software). Social Network Analysis module 410 identifies key influencers, communication bottlenecks, and areas for improvement (i.e., insights). The insights generated are then used as input for other modules.

Visualization and insights generation module 412 develops visualizations and analytics tools to present analyzed data and provide actionable insights to users (e.g., human and agents). The visualizations and analytics tools may include interactive dashboards, heatmaps, and network diagrams that highlight important interactive patterns (i.e., insights). The resulting insights are then used as input for other modules.

Continuous monitoring and refinement module 414 conducts comprehensive testing of collective behavior analysis component 402 to validate the effectiveness of collective behavior analysis component 402 in analyzing collective behavior (e.g., collective interactions).

Still referring to FIG. 4, again, the modules within collective behavior analysis component 402 work together in a coordinated workflow to analyze and enhance collaborative systems. Initially, data collection and preprocessing module 404 gathers and cleans relevant data from collaborative platforms, such as project management tools or shared drives. This cleaned data is then passed to the feature extraction module 406, which identifies and extracts key attributes and patterns related to team interactions and behaviors. Next, machine learning model training module 408 uses the extracted features to train algorithms that uncover insights such as shared goals and interaction patterns. These insights are helpful for social network analysis module 410, which maps the structure and dynamics of the project team, identifying key influencers and communication bottlenecks. The insights from social network analysis module 410, along with those from machine learning, feed into visualization and insights generation module 412, which produces visual tools like interactive dashboards and heatmaps to present actionable data to human users and agents. Finally, continuous monitoring and refinement module 414 ensures the overall effectiveness of collective behavior analysis component 402 by testing and validating performance in analyzing collective behavior or interactions of collective behavior analysis component 402. This feedback loop (provided by continuous monitoring and refinement module 414) helps in continuously improving collective behavior analysis component 402's ability to monitor and enhance team collaboration and synchronization.

With reference to FIG. 5, this figure depicts a block diagram 500 of a reinforcement learning adaptation component 502 in accordance with an illustrative embodiment. It should be noted that a reinforcement learning adaptation component 502 is an instance of reinforcement learning for adaption sub-component 210 mentioned earlier. In the illustrated embodiment, a reinforcement learning adaptation component 502 includes one or more of the following modules: define reinforcement learning framework module 504 (e.g., define reinforcement learning framework module 236), design reward system module 506 (e.g., design reward system module 238), model training module 508, adaptive behavior integration 510 (e.g., adaptive behavior integration 240), user feedback collection 512 (e.g., user feedback collection 244), and continuous monitoring and optimization 514 (e.g., and continuous monitoring and optimization 242). These modules may interrelate, communicate (e.g., Representational state transfer (RESTful) Application Program Interfaces (APIs) for communication between the digital human emulation component and other system modules, Open Authorization (OAuth) for secure user authentication, JavaScript Object Notation (JSON) or Extensible Markup Language (XML) for data exchange, or WebSocket for real-time interaction), and interact in a workflow to enable the functionality of reinforcement learning adaptation component 502 as further detailed below.

Define Reinforcement Learning Framework module 504 identifies and selects the most appropriate reinforcement learning framework for the collaborative system, such as Q-learning, Deep Q-Network (DQN), or Proximal Policy Optimization (PPO). This selection is made based on the collaborative system's specific requirements, ensuring optimal or appropriate performance and alignment with the desired outcomes.

Design Reward System module 506 establishes a reward system that promotes desired behaviors and outcomes within the collaborative system. Design Reward System module 506 defines positive rewards identifying actions that enhance synchronization and performance of a project team using the collaborative system, and negative rewards for actions that impede collaboration among the project team members. Additionally, design reward system module 506 ensures that the reward system aligns with the goals of the Reinforcement Learning Adaptation component 502 and promotes effective behavior and interactions within the collaborative system.

Model training module 508 trains reinforcement learning models using the defined reward system and collected user feedback. Model Training module 508 utilizes techniques such as exploration-exploitation strategies and experience replay to enhance the human-emulative digital model learning process and improve their effectiveness.

Adaptive behavior integration module 510 integrates the trained reinforcement learning models into the decision-making processes of digital humans. Adaptive behavior integration module 510 module enables human-emulative digital models to adapt their behaviors based on received rewards and user feedback, adjusting their actions to optimize synchronization and performance.

User feedback collection module 512 implements mechanisms to gather user feedback on the behaviors and performance of human-emulative digital models. This user feedback is collected through various methods, for example, explicit ratings, surveys, and implicit feedback derived from project team members or user interactions and task outcomes.

Continuous monitoring and refinement module 514 performs comprehensive testing of reinforcement learning adaptation component 502 to assess reinforcement learning adaptation component 502 effectiveness in adapting to and analyzing collective behavior (e.g., collective interactions). Continuous monitoring and refinement module 514 ensures that the reinforcement learning adaptation component 502 remains effective and accurate in real-world applications through ongoing monitoring and refinement.

Still referring to FIG. 5, again, components of reinforcement learning adaptation component 502 work together to enhance the effectiveness of human-emulative digital models within a collaborative system (e.g., a share drive, or project management software). Define reinforcement learning framework module 504 is foundational, as define reinforcement learning framework module 504 selects the most suitable or appropriate reinforcement learning framework based on the specific requirements of the collaborative system. This selection determines the methodologies and algorithms that will be used throughout other components of reinforcement learning adaptation component 502. Once the reinforcement learning framework is defined, design reward system module 506 establishes a reward structure that aligns with the collaborative system's goals. Design reward system module 506 creates a reward system that encourages desirable behaviors and discourages actions that hinder performance, setting the criteria for evaluating the human-emulative digital models. Model training module 508 then takes the output from design reward system module 506 and uses the output to train reinforcement learning models (e.g., human-emulative digital models). Model training module 508 employs techniques such as exploration-exploitation and experience replay to refine these reinforcement learning models. Trained reinforcement learning models are integrated through the adaptive behavior integration module 510, which adapts the behaviors of human-emulative digital models based on the rewards and user feedback received, ensuring that the human-emulative digital models adjust their actions to optimize synchronization and performance within the collaborative system. Additionally, user feedback collection module 512 plays a helpful role in providing the data or information necessary for the training and refinement processes for the human-emulative digital models. User feedback collection module 512 collects feedback from users (e.g., human and agents) on the performance of the human-emulative digital models, using explicit and implicit methods to gather insights on the effectiveness of human-emulative digital model. This feedback informs the ongoing adjustments made by adaptive behavior integration module 510. Finally, continuous monitoring and refinement module 514 oversees the operation of reinforcement learning adaptation component 502, ensuring that the reinforcement learning adaptation component 502 remains effective.

With reference to FIG. 6, this figure depicts a block diagram 600 of a user interface and personalization component 602 in accordance with an illustrative embodiment. It should be noted that user interface and personalization component 602 is an instance of user interface and personalization sub-component 210 mentioned earlier. In the illustrated embodiment, user interface and personalization component 602 includes one or more of the following modules: user research analysis module 604 (e.g., user interface design module 246), information architecture and wireframing module 606 (e.g., user interface design module 246), visual design and branding module 608 (e.g., user interface design module 246), responsive web development module 610 (e.g., contextual adjustments module 250 and adaptive support module 256), real-time guidance and feedback integration module 612 (e.g., real time guidance and feedback 248), personalization implementation module 614 (e.g., personalization module 254), and usability testing and iteration module 616 (e.g., testing and iteration module 252). These modules may interrelate, communicate (e.g., Representational state transfer (RESTful) Application Program Interfaces (APIs) for communication between the digital human emulation component and other system modules, Open Authorization (OAuth) for secure user authentication, JavaScript Object Notation (JSON) or Extensible Markup Language (XML) for data exchange, or WebSocket for real-time interaction), and interact in a workflow to enable the functionality user interface and personalization component 602 as further detailed below.

User research analysis module 604 is designed to gather and analyze data on user behaviors, preferences, and needs to inform the design and functionality of the user interface. User research analysis module 604 employs various research methodologies, such as surveys, interviews, and usage analytics, to obtain insights into user experiences and requirements. The data collected (by user research analysis module 604) is then use to make informed decisions about user interface design, ensuring that the user experience is tailored to meet the needs and expectations of the target audience effectively.

Information architecture and wireframing module 606 establishes an information architecture that effectively organizes the content and functionality of the collaborative system. Additionally, information architecture and wireframing module 606 develops wireframes to define the layout, navigation, and interaction flow of the user interface (e.g., user interface (UI) device set 123).

Responsive Web Development module 610 implements the user interface using web development technologies and frameworks. Responsive Web Development module 610 module ensures that the user interface (e.g., user interface (UI) device set 123) is responsive and accessible across various devices and screen sizes, providing a consistent and user-friendly experience.

Real-time Guidance and Feedback Integration module 612 integrate natural language generation algorithms to provide real-time guidance and feedback within the user interface (e.g., user interface (UI) device set 123) provided through a digital assistant. Generate informative and contextually relevant responses from the human-emulative digital models to support user or team member interactions.

Personalization implementation module 614 integrates natural language generation algorithms into the user interface (e.g., user interface (UI) device set 123) to provide real-time guidance and feedback. Personalization implementation module 614 generates informative and contextually relevant responses from human-emulative digital models through digital assistants to enhance and support user or team member interactions.

Usability testing and iteration module 616 conduct usability testing with representative users or human team members to assess the effectiveness and user-friendliness of the user interface and personalization features. Usability testing and iteration module 616 collect feedback to identify areas for enhancement, and iterate on the user interface design (e.g., user interface (UI) device set 123) and implementation as needed to improve the overall user experience.

Still referring to FIG. 6, again, the modules with user interface and personalization component 602 interrelate through a cohesive workflow designed to enhance the user experience or project member experience. User research analysis module 604 provides useful insights into user behaviors and preferences, which inform the information architecture and wireframing module 606. Information architecture and wireframing module 606 uses the research data (from User research analysis module 604) to structure content and develop wireframes that define the UI's layout and navigation. Responsive web development module 610 then translates these user interface designs into a functional, adaptive user interfaces that ensures accessibility across different devices that may be employed by project members. real-time guidance and feedback integration Module 612 and personalization implementation module 614 work together to enrich user or project member interactions by providing contextually relevant feedback and personalized responses through natural language generation algorithms. Finally, usability testing and iteration module 616 collects feedback on the user interface's effectiveness, feeding this information back into the design process to refine and improve user interface and personalization component 602.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer implemented method for engendering synchronization within a team, the method comprising:
analyzing collective interactions between members within the team;
identifying at least one shared goal and interaction pattern based on the analyzed collective interactions;
training a human-emulative digital model, using a deep learning algorithm, based on the at least one share goal and interaction pattern; and
displaying a digital assistant on a user interface, the digital assistant employing the trained human-emulative digital model.

2. The method of claim 1, wherein: the members within the team include at least one agent and at least one human.

3. The method of claim 1, wherein: the members within the team include at least two agents and at least two humans, with a first agent interacting with a first human and a second agent interacting with a second human.

4. The method of claim 3, wherein: the deep learning algorithm is a Recurrent Neural Networks (RNNs) network.

5. The method of claim 4, further comprises: interacting, using the digital assistant, a first human member from the members within the team, tailored to one or more sensory preferences of the first human member.

6. The method of claim 3, further comprises: interacting, using the digital assistant, a first human member from the members within the team, tailored to one or more sensory preferences of the first human member.

7. The method of claim 2, further comprises: interacting, using the digital assistant, a first human member from the members within the team, tailored to one or more sensory preferences of the first human member.

8. A computer usable program product comprising one or more computer readable storage media, and program instructions collectively stored on the one or more computer readable storage media, the program instructions executable by a processor to cause the processor to perform operations engendering synchronization within a team comprising:
analyzing collective interactions between members within the team;
identifying at least one shared goal and interaction pattern based on the analyzed collective interactions;
training a human-emulative digital model, using a deep learning algorithm, based on the at least one share goal and interaction pattern; and
displaying a digital assistant on a user interface, the digital assistant employing the trained human-emulative digital model.

9. The computer usable program product of claim 8, wherein: the members within the team include at least one agent and at least one human.

10. The computer usable program product of claim 8, wherein: the members within the team include at least two agents and at least two humans, with a first agent interacting with a first human and a second agent interacting with a second human.

11. The computer usable program product of 10, wherein: the deep learning algorithm is a Recurrent Neural Networks (RNNs) network.

12. The computer usable program product of 11, further comprises: interacting, using the digital assistant, a first human member from the members within the team, tailored to one or more sensory preferences of the first human member.

13. The computer usable program product of claim 10, further comprises: interacting, using the digital assistant, a first human member from the members within the team, tailored to one or more sensory preferences of the first human member.

14. The computer usable program product of claim 9, further comprises: interacting, using the digital assistant, a first human member from the members within the team, tailored to one or more sensory preferences of the first human member.

15. A computer system comprising a processor and one or more computer readable storage media, and program instructions collectively stored on the one or more computer readable storage media, the program instructions executable by the processor to cause the processor to perform operations engendering synchronization within a team comprising:
analyzing collective interactions between members within the team;
identifying at least one shared goal and interaction pattern based on the analyzed collective interactions;
training a human-emulative digital model, using a deep learning algorithm, based on the at least one share goal and interaction pattern; and
displaying a digital assistant on a user interface, the digital assistant employing the trained human-emulative digital model.

16. The computer system of claim 15, wherein: the members within the team include at least one agent and at least one human.

17. The computer system of claim 15, wherein: the members within the team include at least two agents and at least two humans, with a first agent interacting with a first human and a second agent interacting with a second human.

18. The computer system of claim of 17, wherein: the deep learning algorithm is a Recurrent Neural Networks (RNNs) network.

19. The computer system of claim of 18, further comprises: interacting, using the digital assistant, a first human member from the members within the team, tailored to one or more sensory preferences of the first human member.

20. The computer system of claim of 17, further comprises: interacting, using the digital assistant, a first human member from the members within the team, tailored to one or more sensory preferences of the first human member.
